(19) United States
(12) Patent Application Publication
(10) Pub. No.: US 2024/0408900 A1
(43) Pub. Date: Dec. 12, 2024

(54) DRYING APPARATUS

(71) Applicant: KYOCERA Document Solutions Inc., Osaka (JP)

(72) Inventors: Minoru TOKONAMI, Osaka-shi (JP); Mitsuhiro GODA, Osaka-shi (JP); Masaki MURASHIMA, Osaka-shi (JP); Hiroyuki UEDA, Osaka-shi (JP)

(73) Assignee: KYOCERA Document Solutions Inc., Osaka (JP)

(21) Appl. No.: 18/733,383

(22) Filed: Jun. 4, 2024

(30) Foreign Application Priority Data
Jun. 7, 2023 (JP) 2023-093718

(51) Int. Cl. B41J 11/00; B41J 13/03; B41J 13/076; B41J 13/08

(52) U.S. Cl. CPC B41J 11/00222; B41J 13/03; B41J 13/076; B41J 13/08

(57) ABSTRACT

A drying apparatus includes a conveying device, a heating device, a conveying rollers pair, a driving roller rotation detection part, a driven roller rotation detection part, and a control part. The conveying device conveys a medium in a conveyance direction. The heating device dries the ink of the medium under a high temperature environment. The conveying rollers pair is disposed on a downstream side of the heating device, and includes a driving roller and a driven roller. The driving roller rotation detection part detects a rotating of the driving roller. The driven roller rotation detection part detects a rotating of the driven roller. The control part stops the heating device when the rotating of the driving roller is detected by the driving roller rotation detection part and a rotation period obtained by a detection result of the driven roller rotation detection part is longer than a reference rotation period.

### INCORPORATION BY REFERENCE

This application is based on and claims the benefit of priority from Japanese patent application No. 2023-093718 filed on Jun. 7, 2023, which is incorporated by reference in its entirety.

### BACKGROUND

The present disclosure relates to a drying apparatus which dries a medium on which an image is formed with ink, under a high temperature environment while conveying the medium.

An image forming system including an inkjet recording apparatus is provided with a drying apparatus which dries the image (ink) formed on the medium. In such a drying apparatus, a reflection type or transmission type optical sensor is often used to detect a medium conveyance failure. In the drying apparatus, a reflection type optical sensor may be disposed on the upstream side of the drying chamber, and a transmission type optical may be disposed in the drying chamber. The upstream optical sensor detects that the sheet (medium) is carried in the drying chamber, and the downstream optical sensor detects that the sheet is carried out from the drying chamber.

However, in the above-described drying apparatus, after the leading end of the long medium is discharged from the drying chamber, if a medium conveyance failure occurs and the medium stays in the drying chamber, there is a problem that it is impossible to detect the medium conveyance failure quickly.

### SUMMARY

A drying apparatus according to the present disclosure includes a conveying device, a heating device, a conveying rollers pair, a driving roller rotation detection part, a driven roller rotation detection part, and a control part. The conveying device conveys a medium on which an image is formed with ink, in a predetermined conveyance direction. The heating device dries the ink of the medium conveyed by the conveying device under a high temperature environment. The conveying rollers pair is disposed on a downstream side of the heating device in the conveyance direction, includes a driving roller driven to be rotated and a driven roller rotated by the driving roller, and conveys the medium passed through the heating device. The driving roller rotation detection part detects a rotating of the driving roller. The driven roller rotation detection part detects a rotating of the driven roller. The control part stops the heating device when the rotating of the driving roller is detected by the driving roller rotation detection part and a rotation period obtained by a detection result of the driven roller rotation detection part is longer than a reference rotation period.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing a drying apparatus according to one embodiment of the present disclosure.

FIG. 2A is a view showing a conveying rollers pair and a rotation detection sensor (when an ON signal is output), in the drying apparatus according to the embodiment of the present disclosure.

FIG. 2B is a view showing the conveying rollers pair and the rotation detection sensor (when an OFF signal is output), in the drying apparatus according to the embodiment of the present disclosure.

FIG. 2C is a view showing an example of an output waveform of the rotation detection sensor, in the drying apparatus according to the embodiment of the present disclosure.

FIG. 3A is a view showing the conveying rollers pair and the rotation detection sensor (when an OFF signal is output) when the conveying of the medium is stopped, in the drying apparatus according to the embodiment of the present disclosure.

FIG. 3B is a view showing an example of an output waveform of the rotation detection sensor when the conveying of the medium is stopped, in the drying apparatus according to the embodiment of the present disclosure.

FIG. 4A is a view showing the conveying rollers pair and the rotation detection sensor (when an ON signal is output) when the medium conveying speed is decreased, in the drying apparatus according to the embodiment of the present disclosure.

FIG. 4B is a view showing the conveying rollers pair and the rotation detection sensor (when an OFF signal is output) when the medium conveying speed is decreased, in the drying apparatus according to the embodiment of the present disclosure.

FIG. 4C is a view showing an example of an output waveform of the rotation detection sensor when the medium conveying speed is decreased, in the drying apparatus according to the embodiment of the present disclosure.

FIG. 5A is a view showing the conveying rollers pair and the rotation detection sensor (when an ON signal is output), in a modified example of the drying apparatus according to the embodiment of the present disclosure.

FIG. 5B is a view showing the conveying rollers pair and the rotation detection sensor (when an OFF signal is output), in the modified example of the drying apparatus according to the embodiment of the present disclosure.

FIG. 5C is a view showing an example of an output waveform of the rotation detection sensor, in the modified example of the drying apparatus according to the embodiment of the present disclosure.

### DETAILED DESCRIPTION

Hereinafter, with reference to the drawings, a drying apparatus according to one embodiment of the present disclosure will be described.

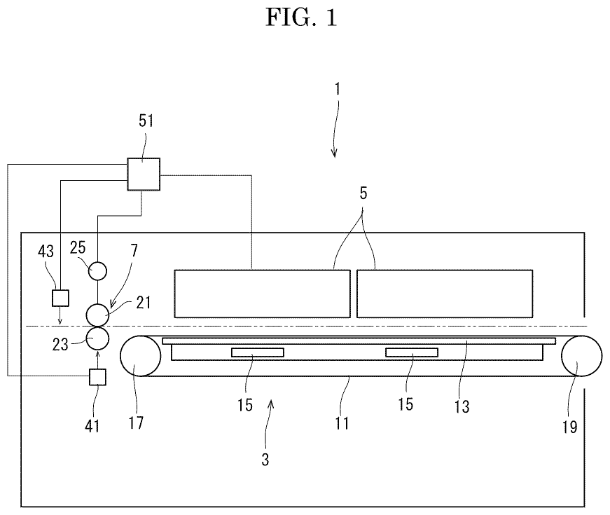

First, the entire structure of the drying apparatus 1 will be described with reference to FIG. 1. FIG. 1 is a front view showing the inside of the drying apparatus 1. The drying apparatus 1 includes a conveying device 3, a heating device 5, and a conveying rollers pair 7. The conveying device 3 conveys a medium on which an image is formed by an inkjet method along a conveyance direction (a direction from the right to the left in FIG. 1). The heating device 5 dries ink of the medium conveyed by the conveying device 3 under a high-temperature environment. The conveying rollers pair 7 conveys the medium passed through the heating device 5.

First, the conveying device 3 will be described. The conveying device 3 includes a conveying belt 11 which conveys the medium, a conveying plate 13 which supports the conveying belt 11, and a suction device 15 which attracts the medium to the conveying belt 11.

The conveying belt 11 is an endless belt, and a number of through-holes penetrating in the thickness direction are formed over the entire surface. The conveying belt 11 is wound around a driving roller 17 and a driven roller 19. When the driving roller 17 is driven by a motor (not shown) to be rotated, the conveying belt 11 travels in the counterclockwise direction of FIG. 1. The outer surface of the conveying belt 11 along the upper track becomes the conveying surface on which the medium (a cut sheets, a long sheet, or the others) is conveyed.

The conveying plate is in contact with the inner circumferential surface (the surface opposite to the conveying surface) of the conveying belt 11 traveling on the upper track to support the conveying belt 11. When the conveying belt 11 travels, the inner circumferential surface of the conveying belt 11 slides along the upper surface of the conveying plate 13. A number of through-holes penetrating in the thickness direction are formed over the entire surface of the conveying plate 13.

The suction device 15 is disposed in the inside space of the conveying belt 11. When the suction device 15 is driven, air in the through-holes of the conveying belt 11 and the through-holes of the conveying plate 13 is taken in, and the medium is attracted to the conveying surface of the conveying belt 11.

Next, the heating device 5 will be described. The heating device 5 is disposed above the conveying device 3, and includes air blowing fans and a heater unit (both of which are not shown). The air blowing fan takes in air and generates an air flow directed downward. The heater unit heats the generated air flow. The heating device 5 is electrically connected to a control part 51.

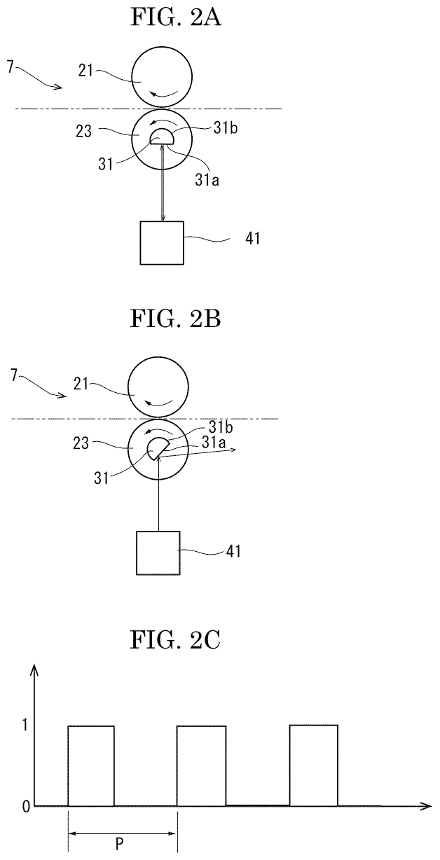

Next, the conveying rollers pair 7 will be described with reference to FIG. 1, FIG. 2A, FIG. 2B, and FIG. 2C. FIG. 2A and FIG. 2B show the conveying rollers pair 7 and a rotation detection sensor 41, and FIG. 2C shows an example of an output waveform of the rotation detection sensor 41.

As shown in FIG. 1, the conveying rollers pair 7 is disposed on the downstream side of the heating device 5 in the conveyance direction of the medium. The conveying rollers pair 7 includes a driving roller 21 and a driven roller 23. The driving roller 21 is connected to the motor 25, and driven by the motor 25 to be rotated. The motor 25 is electrically connected to the control part 51.

The driven roller 23 is rotated in accordance with the rotating of the driving roller 21 or the medium conveyed by the rotating of the driving roller 21. As shown in FIG. 2A and FIG. 2B, the end portion 31 of the rotating shaft of the driven roller 23 is formed in a D-cut shape. That is, the end portion 31 has a flat surface 31a parallel to the rotating shaft and a curved surface 31b along the circumferential direction of the rotating shaft.

The rotating of the driven roller 23 is detected by a rotation detection sensor 41. The rotation detection sensor 41 is an optical sensor having a light emitting part for emitting light and a light receiving part for receiving the light. The rotation detection sensor 41 is arranged below the end portion 31 of the rotating shaft of the driven roller 23 such that the light emitted from the light emitting part is applied to the end portion 31 of the rotating shaft of the driven roller 23. The rotation detection sensor 41 is electrically connected to the control part 51 (see FIG. 1), and transmits an ON signal or an OFF signal to the control part 51 based on the detection result.

That is, as shown in FIG. 2A, when the light emitted from the light emitting portion is applied to the flat surface 31a substantially perpendicularly, the light is reflected substantially perpendicularly on the flat surface 31a and then received by the light receiving part. Then, the rotation detection sensor 41 outputs an ON signal. On the other hand, as shown in FIG. 2B, when the light emitted from the light emitting part is not applied to the flat surface 31a substantially perpendicularly or is applied to the curved surface 31b, the light is reflected in a direction different from the direction toward the light receiving portion and is not received by the light receiving part, so that the rotation detection sensor 41 outputs an OFF signal. The light receiving part of the rotation detection sensor 41 is capable of receiving not only the light reflected perpendicularly on the flat surface 31a, but also the light reflected on the flat surface 31a within a predetermined range.

As a result, every time when the driven roller 23 rotates once, “1” indicating the ON signal and “0” indicating the OFF signal appear on the output waveform of the rotation detection sensor 41. Therefore, when the driven roller 23 is rotated, “1” and “0” appear at a constant reference rotation period P, as shown in FIG. 2C.

Further, as shown in FIG. 1, a medium detection sensor 43 is disposed on the downstream side of the conveying rollers pair 7 in the conveyance direction. The medium detection sensor 43 is an optical sensor having a light emitting part for emitting light and a light receiving part for receiving the light emitted from the light emitting part and reflected by the medium conveyed by the conveying rollers pair 7. The medium detection sensor 43 is electrically connected to the control part 51, and outputs an ON signal or an OFF signal to the control part 51 based on the detection result.

Next, the control part 51 will be described with reference to FIG. 1. The control part 51 controls the heating device 5 (the air blowing fan and the heater unit) to drive or stop driving the heating device 5.

The control part 51 drives or stops the driving of the motor 25 for rotating the driving roller 21 of the conveying rollers pair 7. Further, to the control part 51, the ON signal or the OFF signal is input from the rotation detection sensor 41. The control part 51 calculates a rotation period of the driven roller 19 based on the input signal. The control part 51 stores in advance a reference rotation period of the driven roller 19 when the medium is normally conveyed by the conveying rollers pair 7. The reference rotation period is determined on the basis of the time at which a failure occurs in the medium by the heating device 5. Further, to the control part 51, the ON signal or the OFF signal is input from the medium detection sensor 43.

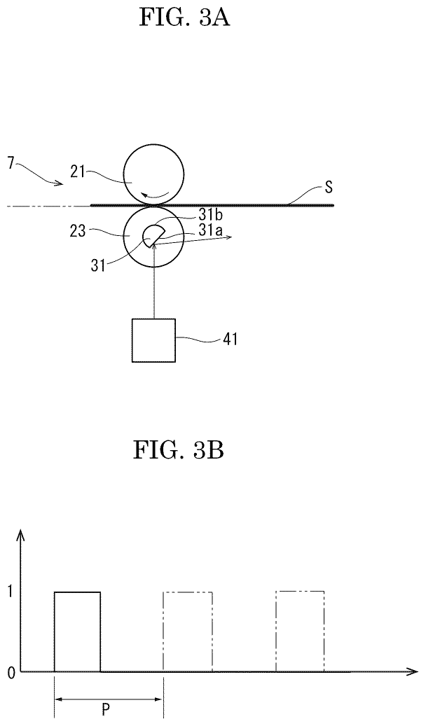

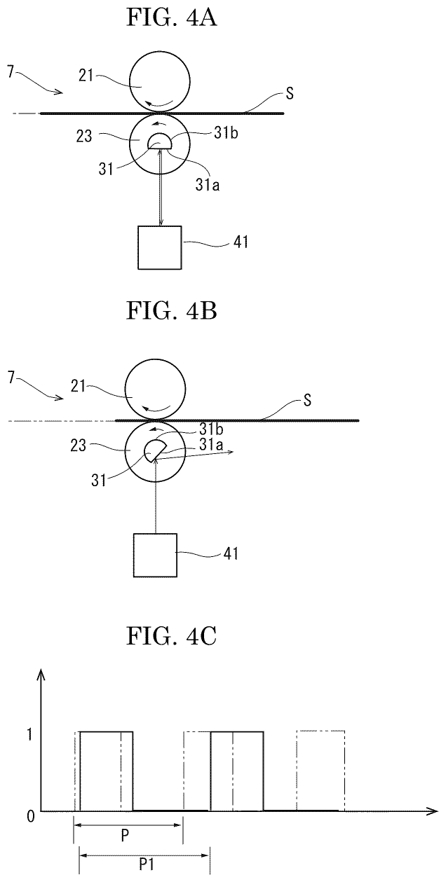

The drying operation of the drying apparatus 1 having the above configuration will be described with reference to FIG. 1, FIG. 3A, FIG. 3B, FIG. 4A, FIG. 4B, and FIG. 4C. FIG. 3A is a view showing the conveying rollers pair 7 and the rotation detection sensor 41 when the conveying of the medium is stopped, and FIG. 3B is a view showing an example of an output waveform of the rotation detection sensor 41 when the conveying of the medium is stopped. FIG. 4A and FIG. 4B are views showing the conveying rollers pair 7 and the rotation detection sensor 41 when the medium conveying speed is decreased, and FIG. 4C is a view showing an example of an output waveform of the rotation detection sensor 41 when the medium conveying speed is decreased.

In the conveying device 3, the driving roller 17 is driven to be rotated, and the conveying belt 11 travels. Thereafter, the medium on which the image is formed by the inkjet method is conveyed to the conveying surface of the conveying belt 11. Further, the suction device 15 is driven. Thereby, as described above, the air in the through-holes of the conveying belt 11 and the through-holes of the conveying plate 13 is taken in, and the pressure in the space above the conveying surface of the conveying belt 11 becomes negative. Then, the medium is attracted to the conveying surface. Thus, the medium is conveyed along the conveyance direction while being attracted to the conveying surface of the conveying belt 11.

Further, the control part 51 drives the heating device 5. Thus, the air taken in by the air blowing fan is blown downward. The blown air is heated by the heater unit, and the heated air is blown against the medium conveyed by the conveying device 3. Thus, the ink of the medium is dried. The ink-dried medium is conveyed from the conveying belt 11 to the conveying rollers pair 7, and conveyed downstream by the conveying rollers pair 7. That is, the motor 25 is driven to rotate the driving roller 21, and the driven roller 23 is rotated in accordance with the medium conveyed by the rotating of the driving roller 21. The rotating of the driven roller 23 is detected by the rotation detection sensor 41. The detection result of the rotation detection sensor 41 is output to the control part 51.

The control part 51 calculates the rotation period of the driven roller 23 based on the detection result of the rotation detection sensor 41. The control part 51 compares the calculated rotation period with the stored reference rotation period P. Further, the control part 51 determines whether the motor 25 driving the driving roller 21 is driving. When the control part 51 determines that the calculated rotation period is longer than the reference rotation period P and that the motor 25 is driving, it stops driving of the heating device 5.

That is, as shown in FIG. 3B, when the output waveform of the rotation detection sensor 41 shows “1” indicating the ON signal and then continuing “0” indicating the OFF signal, the control part 51 determines that the driven roller 23 is not rotated. As shown in FIG. 3A, when the driven roller 23 is not rotated even when the driving roller 21 is rotated, the driven roller 23 is not rotated in accordance with the medium, and it can be determined that the medium S is not conveyed. In this case, since the medium S remains in the heating device 5, the driving of the heating device 5 is stopped.

The case where the calculated rotation period is longer than the reference rotation period P (the rotation period in the normal conveying operation) includes the case where “1” indicating the ON signal appears and then continuing “0” indicating the OFF signal appears, as in the above case. Alternatively, the case includes the case where the output waveform of the rotation detection sensor 41 shows continuing “1”. In this case, the rotating of the driven roller 23 is stopped in a state where the light emitted from the rotation detection sensor 41 is applied to the flat surface 31a of the end portion 31 of the rotation shaft of the driven roller 23 almost perpendicularly. This case is also included in the case where the calculated rotation period is longer than the reference rotation period P.

As described above, the control part 51 is an example of the driving roller rotation detecting part which detects the rotating of the driving roller 21 in the present disclosure, and the rotation detection sensor 41 is an example of the driven roller rotation detecting part which detects the rotating of the driven roller 23.

Alternatively, as shown in FIG. 4C, when the control part 51 determines that the rotation period P1 of the rotation detection sensor 41 is longer than the reference rotation period P and that the motor 25 is driving, it stops the driving of the heating device 5. That is, if the rotation period P1 of the rotation detection sensor 41 is longer than the reference rotation period P, as shown in FIG. 4A and FIG. 4B, even if the driving roller 21 is rotated, the rotation speed of the driven roller 23 rotating in accordance with the medium S becomes slow, and it can be determined that the conveying speed of the medium S is slow. In this case, in the case of the long medium S, the time for conveying the medium S in the heating device 5 becomes long, so that the control part 51 stops the driving of the heating device 5.

As is clear from the above description, according to the drying apparatus 1 of the present disclosure, by detecting the rotating of the driven roller 23 rotating in accordance with the medium, it is possible to accurately and quickly detect the stop conveyance of the medium and the decrease in the conveying speed of the medium. When such a conveyance failure is detected, the heating device 5 is stopped immediately, so that the medium does not stay in the high-temperature heating device 5.

Further, the end portion 31 of the driven roller 23 may be processed so that the flat surface 31a has a glossiness higher than the curved surface 31b. For example, the flat surface 31a may be coated with a coating having a high glossiness while the curved surface 31b may be coated with a coating having a lower glossiness than the coating for the flat surface 31a. In this case, since the difference in an amount of the light received by the light receiving part of the rotation detection sensor 41 between the flat surface 31a and the curved surface 31b increases, the rotating of the driven roller 23 can be more accurately grasped.

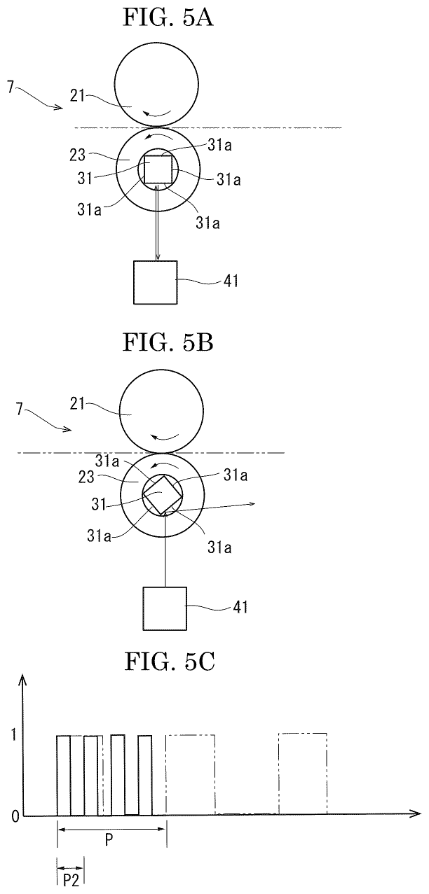

Next, a modified example of the driven roller 23 will be described with reference to FIG. 5A and FIG. 5B. In this modified example, as shown in FIG. 5A and FIG. 5B, the end portion 31 of the rotating shaft of the driven roller 23 is formed in a polygonal shape (in this example, a square shape) in a cross-sectional view. That is, four flat surfaces 31a are formed on the end portion 31 at equal center angles along the circumferential direction. In this case, as shown in FIG. 4A, when the light emitted from the rotation detection sensor 41 reflects substantially perpendicularly on the flat surfaces 31a, the rotation detection sensor 41 outputs the ON signal, and when the light emitted from the rotation detection sensor 41 does not reflect substantially perpendicularly on the flat surfaces 31a, as shown in FIG. 4B, the rotation detection sensor 41 outputs the OFF signal.

In this example, as shown in FIG. 5C, since the ON signal is output four times for each rotating of the driven roller 23, the rotation period P2 is ¼ of the reference rotation period P. Therefore, the conveyance failure of the medium determined from the rotation period can be detected more quickly.

In the present embodiment, the rotation detection sensor 41 receives the light reflected on the D-cut flat surface 31a of the end portion 31 of the rotating shaft of the driven roller 23. However, a pulse plate may be provided on the rotating shaft of the driven roller 23, and the reflection of light on the reflection surface of the pulse plate may be received by the rotation detection sensor 41. However, as in the present embodiment, by receiving the reflection of the light on the D-cut flat surface 31a, the rotation detection sensor 41 can be installed in a relatively narrow space within the length range of the rotating shaft of the driven roller 23.

Although the present disclosure has been described in particular embodiments, the present disclosure is not limited to the foregoing embodiments. To the extent that it does not deviate from the scope and object of the present disclosure, the foregoing embodiments may be variously changed, substituted, or modified, and the claims include all embodiments that may fall within the scope of technical thought.

1. A drying apparatus comprising:
a conveying device which conveys a medium on which an image is formed with ink, in a predetermined conveyance direction;
a heating device which dries the ink of the medium conveyed by the conveying device under a high temperature environment;
a conveying rollers pair which is disposed on a downstream side of the heating device in the conveyance direction, includes a driving roller driven to be rotated and a driven roller rotated by the driving roller, and conveys the medium passed through the heating device;
a driving roller rotation detection part which detects a rotating of the driving roller;
a driven roller rotation detection part which detects a rotating of the driven roller; and
a control part which stops a driving of the heating device when the rotating of the driving roller is detected by the driving roller rotation detection part and a rotation period obtained by a detection result of the driven roller rotation detection part is longer than a reference rotation period.

2. The drying apparatus according to claim 1, wherein
the reference rotation period is determined on the basis of a time at which a failure occurs in the medium by the heating device.

3. The drying apparatus according to claim 1, wherein
the driven roller rotation detection part is a reflection type sensor including a light emitting part which emits light to an end portion of a rotating shaft of the driven roller and a light receiving part which receives the light emitted from the emitting part and reflected on the end portion.

4. The drying apparatus according to claim 3, wherein
the end portion of the rotating shaft of the driven roller has a flat surface parallel to an axis direction of the rotating shaft and a curved surface along a circumferential direction of the rotating shaft, and
the driven roller rotation detection part detects the rotating of the driven roller when the receiving part receives the light emitted from the emitting part and reflected on the flat surface.

5. The drying apparatus according to claim 4, wherein
the flat surface has a glossiness higher than a glossiness of the curved surface.

6. The drying apparatus according to claim 3, wherein
the end portion of the rotating shaft of the driven roller is formed to be a rectangular cross-section so as to have a plurality of flat surfaces provided at equal angles in a circumferential direction of the rotating shaft and parallel to the axial direction of the rotating shaft, and
the driven roller rotation detection part detects the rotating of the driven roller when the light receiving part receives the light emitted from the light emitting part and reflected on the flat surfaces.

7. The drying apparatus according to claim 1, further comprising:
a motor which rotates the driving roller, wherein
the control part drives the motor and stops the driving of the motor, and
the driving roller rotation detection part is the control part.
